(19) United States
(12) Patent Application Publication
(10) Pub. No.: US 2008/0036464 A1
(43) Pub. Date: Feb. 14, 2008

(54) Probes and methods for semiconductor wafer analysis

(75) Inventors: Kenneth Steeples, Billerica, MA (US); Edward Tsidilkovski, Chelmsford, MA (US); William Goldfarb, Malden, MA (US)

Correspondence Address: Kirkpatrick & Lockhart Preston Gates Ellis LLP;(FORMERLY KIRKPATRICK & LOCKHART NICHOLSON GRAHAM), STATE STREET FINANCIAL CENTER, One Lincoln Street, BOSTON, MA, 02111-2950, US

(73) Assignee: QC Solutions, Inc., Billerica, MA (US)

(21) Appl. No.: 11/881,730

(22) Filed: Jul. 27, 2007

Related U.S. Application Data
(60) Provisional application No. 60/833,710, filed on Jul. 27, 2006.

(51) Int. Cl. G01N 27/60

(52) U.S. Cl. 324/452

(57) ABSTRACT

A probe adapted for characterization of a semiconductor wafer having a surface. In one embodiment, the probe includes a source of modulated light; an optical fiber in optical communication with the source of modulated light, the optical fiber having a face and comprises a fiber core; and a transparent conductive layer coating the face of the optical fiber. Light from the source of modulated light is directed along the fiber core of the optical fiber through the face of the optical fiber to the surface of the semiconductor wafer. The optically transparent conductive layer detects charges from the surface of the semiconductor wafer.

### RELATED APPLICATIONS

This application claims priority to and the benefit of U.S. provisional patent application No. 60/833,710 the entire disclosure of which is incorporated by reference herein.

### FIELD OF THE INVENTION

The invention relates to devices and methods for testing semiconductor wafers during manufacturing. Specifically, it relates to a probe for evaluating and characterizing semiconductor materials, such as wafers.

### BACKGROUND OF THE INVENTION

There are numerous individual operations, or processing steps, performed, in a strictly followed sequence, on a silicon wafer in the course of manufacturing a complex integrated circuit (IC). Each such operation must be precisely controlled in order to assure that the entire fabrication process yields integrated circuits displaying the required electrical characteristics.

Frequently, failure of an individual operation is detected only after the completion of the entire, very expensive, process of IC fabrication. Due to the very high cost of advanced IC fabrication processes, such failures result in the severe financial losses to the integrated circuit manufacturer. Therefore detection of errors in the manufacturing process, immediately after their occurrence, could prevent the unnecessary continuation of the fabrication of devices which are destined to malfunction, and hence, could substantially reduce the financial losses resulting from such errors.

Process monitoring in semiconductor device manufacturing relies upon the examination of the changes, which occur in certain physical and/or chemical properties of the silicon wafer upon which the semiconductor devices are fabricated. These changes may occur following the various processing steps to which the silicon wafer is subjected and are reflected by changes in the electrical properties of the wafer. Therefore, by monitoring selected electrical properties of the silicon wafer in the course of IC fabrication, an effective control over the manufacturing process can be accomplished.

Not all of the electrical characteristics of a completed integrated circuit can be predicted based on the measurements performed on a partially processed wafer. Most of the characteristics however, can be predicted directly or indirectly based on the investigation of the condition of the surface of the silicon wafer (substrate) in the course of IC manufacture. The electrical condition of the silicon surface is very sensitive to the outcome of the individual processing steps that are applied during IC manufacturing. Hence, the measurement of the electrical properties of the substrate surface (surface charge profiling) can be an effective tool by which the monitoring of the outcome of the individual processing steps can be accomplished.

The determination of the electrical characteristics of the wafer surface typically requires physical contact with the wafer surface, or the placement of a contactless probe over a stationary wafer. In the latter case an optical signal or an electric field is used to disturb equilibrium distribution of the electrons and holes in the surface and near-surface region of semiconductor. Typically, the degree of departure from equilibrium is driven by variations of one or more electrical characteristics of the surface region, the near-surface region, and the bulk of the semiconductor. To obtain a more complete picture of the entire surface of the wafer, several measurements at various points on the surface can be made. Such a procedure, known as “mapping” performs a measurement at each location before the measuring device moves on to the next location. The substrate, in this procedure, typically does not remain in continuous motion, in contrast to the “mapping” technique of SCP applied to bare or unpatterned wafers, where a continuous combination of rotary/linear motions are used to “map” the entire surface, limited by the resolution of the measuring device sensor or spot size.

The use of photovoltage response in semiconductors to monitor implant processing, epitaxial doping trace metallic contamination, and strained silicon (through Si—Ge and Si—C) has been well documented (see U.S. Pat. Nos. 5,661,408, 6,067,017, 6,315,574, 6,909,302, 6,924,657, 6,911,350, and 7,119,569). The SCP method disclosed in these patents typically involves directing a beam of light at a region of the surface of a specimen of semiconductor material, measuring the photo-induced change in electrical potential at the surface, and determining various electrical characteristics of the wafer based on the induced surface photovoltage (“SPV”).

The interaction of high frequency, chopped light, with single crystal silicon has been treated theoretically through the modulation of surface potential, as illustrated in the P-type silicon band diagram in FIG. 1. Low-level intensity light slightly varies the surface potential through electron-hole production, without changing electrical or optical properties of the semiconductor. If the surface potential is enough to deplete the surface of charge carriers, accurate calculations of doping density can be made for a uniform doping profile. Charge potentials associated with other physical conditions throughout the crystal depth (including polished backside) can be varied through drift and diffusion of photo carriers, in turn causing a measurable surface potential modulation.

However, the SCP method as previously contemplated does not address the measurement on patterned wafers to achieve accurate measurements. In addition, it is also desirable to limit the monitor wafer usage to reduce the cost of implementing this type of wafer testing, especially as wafer substrate and complexity continue to increase.

The disclosed invention addresses these issues.

### SUMMARY OF THE INVENTION

Since semiconductor wafers are used in many electronic devices, enhancing the techniques associated with their testing and manufacturing is of interest to the fabricators and scientists working in the field. Surface charge profiling is one technique by which defects in a wafer can be located and other wafer specific information can be evaluated using non-destructive electro-optical techniques. The aspects of the invention discussed herein offer a new approach and new devices for delivering light and capturing signals and data from a wafer.

Specifically, in part, the invention relates to a probe adapted for characterization of a semiconductor wafer having a surface. The invention also relates to techniques for using a small spot size in conjunction with evaluating and/or characterizing a semiconductor wafer portion. The small spot size is typically generated, in some embodiments, using an optical fiber portion that terminates in a substantially planar endface. The endface serves as both a light delivery mechanism and an electrode. The electrode functionality is achieved by using a transparent conductive material as a portion of the substantially planar endface of the probe which is in optical communication with the fiber and in electrical communication with a processor or other data capture element.

In one aspect, the invention relates to a probe adapted for characterization of a semiconductor material having a surface. The probe includes a source of electromagnetic radiation; an optical fiber portion having a transmission endface, the optical fiber portion in communication with the source of electromagnetic radiation; and a transparent probe section having a substantially planar conductive endface, the transparent probe section positioned relative to the transmission endface such that electrical changes induced in the semiconductor material in response to the electromagnetic radiation are received by the conductive endface.

In one embodiment, the conductive endface senses photovoltage induced on a surface of the semiconductor material by electromagnetic radiation I from the source. The semiconductor material can be a semiconductor wafer. The source can be a light emitting diode. In one embodiment, the conductive endface can be a cap with a substantially planar surface. The conductive endface can include ITO or other suitable selectively transparent conductive materials. The probe can further include a digital signal processor adapted to process electrical signals induced in the conductive endface. The probe section can include a conductive coating that encircles a length of the fiber portion and is in electrical communication with the conductive endface. This coating can serve as a lead for signal processing devices.

In one embodiment, the electromagnetic radiation generates a spot on a surface of the semiconductor material below the transmission endface, the spot associated with at least one wavelength. In some embodiments, the electromagnetic radiation used has a wavelength selected from the group consisting of visible light, infrared light; near infrared light, long visible, short visible, and ultraviolet. The probe can further include a photodetector in optical communication with the fiber portion to provide feedback regarding probe operational parameters.

In another aspect the invention relates to a probe for adapted for characterization of a semiconductor wafer having a surface. The probe includes a source of modulated light adapted to generate light of varying wavelengths; an optical fiber in optical communication with the source of modulated light, the optical fiber having an endface and comprising: a fiber core; and a transparent conductive layer coating the face of the optical fiber, wherein light from the source of modulated light is directed along the fiber core of the optical fiber through the face of the optical fiber to the surface of the semiconductor wafer, and wherein charges from the surface of the semiconductor wafer are detected by the transparent conductive layer.

The transparent conductive layer can extend along a fiber cladding in one embodiment. The probe can further include a photodetector connected to the transparent conductive layer. In one embodiment, there is space between the face of the optical fiber and the surface of the semiconductor. The probe can include a ferrule, wherein the ferrule holds the optical fiber at a fixed distance from the surface of the semiconductor and parallel to the surface of the semiconductor. The ferrule is non-conductive in some embodiments. The probe can further include an opaque sensor disk having a bottom side, wherein the bottom side of the opaque sensor disk is coated with a conductive film which shields the transparent conductive layer from extraneous photo signals.

In another aspect the invention relates to a method of characterizing a portion of a semiconductor material, the method comprising the steps of transmitting electromagnetic radiation using an optical fiber such that the electromagnetic radiation a) propagates through a substantially planar conductive probe endface in communication with the optical fiber and b) impinges on a surface of the semiconductor material; and detecting an electrical signal associated with an electrical change induced in the portion of the semiconductor material in response to the electromagnetic radiation, wherein the electrical signal is detected using the conductive probe endface.

In one embodiment, the probe includes a source of modulated light; an optical fiber in optical communication with the source of modulated light, the optical fiber having an endface portion and comprising a fiber core; a fiber cladding coating a portion of the fiber core; and a transparent electrically conductive layer coating the face of the optical fiber. Light from the source of modulated light is transmitted along the fiber core of the optical fiber through the face of the optical fiber to the surface of the semiconductor wafer. The transparent conductive layer detects charges and/or signals from the surface of the semiconductor wafer. In another embodiment, the transparent conductive layer extends along the fiber cladding.

In yet another embodiment, the probe further includes a photo detector connected to the transparent conductive layer. In another embodiment, the probe further includes a ferrule that holds the optical fiber at a fixed distance from the surface of the semiconductor and parallel to the surface of the semiconductor, through leveling capacitors in a ceramic disc. In yet another embodiment, the probe further includes an opaque sensor disk having a bottom side. The bottom side of the opaque sensor disk is coated with a conductive film that shields the transparent conductive layer from extraneous photo signals.

In another aspect the invention relate to a method of obtaining data with respect to a semiconductor material. The method includes the step of transmitting electromagnetic radiation via an optical fiber core such that it propagates from a probe endface portion in communication with the optical fiber core and impinges on a portion of a surface of the semiconductor material. The method further includes the step of transmitting an electrical signal from a surface.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a P-type silicon band diagram where W_{d} is the surface depletion layer depth; and mid band gap defects from ion implantation are shown;

FIG. 2 is a block diagram of an apparatus including a probe assembly for electrical characterization of a small spot on a semiconductor wafer during manufacturing, according to an embodiment of the invention;

FIG. 3a is a block diagram illustrating a small spot probe, according to an embodiment of the invention;

FIG. 3b is a bottom cross-section view of the small spot probe shown in FIG. 3a, according to an embodiment of the invention;

FIG. 3c is a detailed cross section view of the optical fiber shown in FIG. 3b, according to an embodiment of the invention;

FIG. 3d is a perspective view of a ferrule for supporting the optical fiber, according to an embodiment of the invention;

FIG. 3e is a perspective view of a fiber optic with an electrically conductive optically transparent coating, according to an embodiment of the invention;

FIGS. 3f and 3g are respectively top and bottom perspective views of a ferrule assembled with the fiber optic and conductive coating, according to an embodiment of the invention;

FIG. 3h is a perspective view of a support guard ring, according to an embodiment of the invention;

FIG. 3i is a top perspective view of a probe assembly, according to an embodiment of the invention;

FIGS. 4a and 4b are block diagrams illustrating the small spot probe of FIG. 3a in operation, using long visible infrared (“IR”) light and short visible ultraviolet (“UV”) light respectively, according to an embodiment of the invention;

FIG. 5 is a block diagram illustrating the process of converting signals from the wafer to digital data, according to an embodiment of the invention;

FIG. 6 is an electrical circuit diagram of the small spot probe and its control, according to an embodiment of the invention;

FIG. 7 is a block diagram of another embodiment of a small spot probe; and

FIG. 8 is a photo showing a typical 60 μm spot illumination of diagnostic areas in a partially processed patterned wafer, according to an embodiment of the invention.

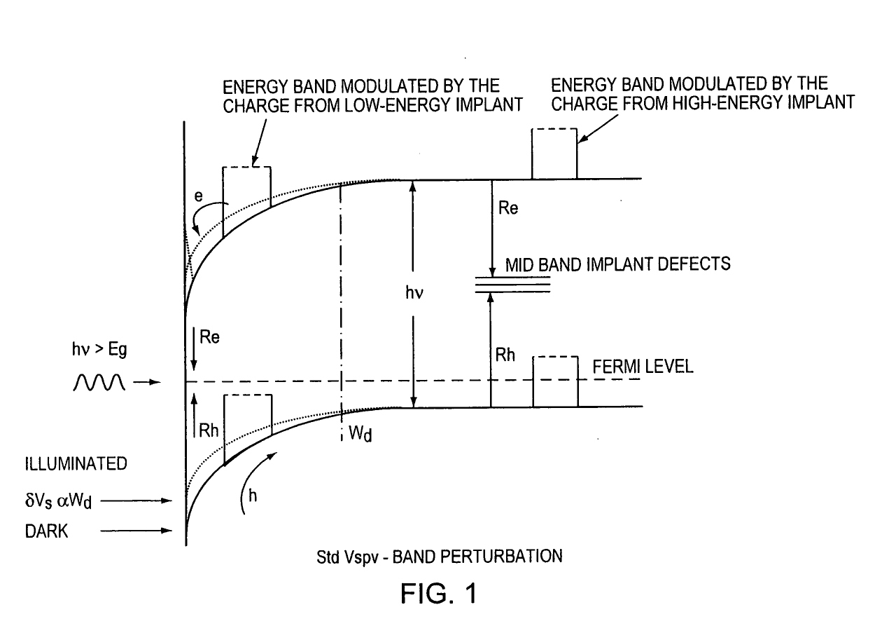

### DETAILED DESCRIPTION OF THE PREFERRED EMBODIMENTS

The present invention will be more completely understood through the following detailed description, which should be read in conjunction with the attached drawings. In this description, like numbers refer to similar elements within various embodiments of the present invention. Within this detailed description, the claimed invention will be explained with respect to preferred embodiments. However, the skilled artisan will readily appreciate that the methods and systems described herein are merely exemplary and that variations can be made without departing from the spirit and scope of the invention.

Since semiconductor wafers are used in many electronic devices, enhancing the techniques associated with their testing and manufacturing is of interest to the fabricators and scientists working in the field. Surface charge profiling is one technique by which defects in a wafer can be located and other wafer specific information can be evaluated using non-destructive electro-optical techniques. The aspects of the invention discussed herein offer a new approach and new devices for delivering light and capturing signals and data from a wafer.

Specifically, in part, the invention relates to a probe adapted for characterization of a semiconductor wafer having a surface. The invention also relates to techniques for using a small spot size in conjunction with evaluating and/or characterizing a semiconductor wafer portion. The small spot size is typically generated, in some embodiments, using an optical fiber portion that terminates in a substantially planar endface. The endface serves as both a light delivery mechanism and an electrode. The electrode functionality is achieved by using a transparent conductive material as a portion of the substantially planar endface of the probe which is in optical communication with the fiber and in electrical communication with a processor or other data capture element.

An optical source such as an LED can be in communication with a separate probe element having a suitable endface for evaluating a wafer portion. In some embodiments, the optical source is integrated with an optical stack that is in communication with the probe element. In other embodiments, the LED includes a fiber tail that is coated and processed to form the probe.

In general, the embodiments of the invention relate to using an optical fiber with a transparent coating to transmit light of varying wavelengths to induce electrical changes in a wafer. An electrode portion, typically formed by a transparent conductive coating, is part of the probe and is adapted to measure changes in surface charge profiles, electron drift, and electron diffusion within a semiconductor material. Before discussing aspects of the probe in further detail, some implementations of performing calculations and capturing signals correlated to wafer information, semiconductor diagnostic information, and defect states are discussed below.

As disclosed in U.S. Pat. Nos. 4,544,887 and 5,661,408, one apparatus suitable for performing various electrical characterizations uses the method for measuring the photo-induced voltage at the surface of semiconductor materials, termed the surface photovoltage (SPV). In this method, a beam of light is directed at a region of the surface of a specimen of semiconductor material and the photo-induced change in electrical potential at the surface is measured. The wavelength of the illuminating light beam is selected to be shorter than the wavelength of light corresponding to the energy gap of the semiconductor material undergoing testing. The intensity of the light beam is modulated, with both the intensity of the light and the frequency of modulation being selected such that the resulting AC component of the induced photovoltage is directly proportional to the intensity of light and inversely proportional to the frequency of modulation.

When measured under these conditions, the AC component of the surface photovoltage (SPV), designated δVₛ, is proportional to the reciprocal of the semiconductor space-charge capacitance, C_{sc}. When the surface of the specimen is illuminated uniformly, the relationship between the surface photovoltage (SPV) and the space-charge capacitance is given, at sufficiently high frequencies of light modulation, by the relation:

$$δ {V}_{s} = \frac{ϕ ( 1 - R )}{Kf} {qC}_{SC}^{- 1}$$

where φ is the incident photon flux, R is the reflection coefficient of the semiconductor specimen, f is the frequency at which the light is modulated, and q is the elementary charge. The constant K is equal to 4 for a square wave modulation of the light intensity and is equal to 2π for sinusoidal modulation.

In the above referenced patent, only a uniform configuration is considered in which the area of the sensor is at least the same size as the semiconductor wafer and the entire area of the specimen is uniformly illuminated. When only a portion of the semiconductor specimen surface is coupled to the sensor, that is, when the sensor is smaller than the wafer, and when the semiconductor surface uniformly illuminated in that area is coupled to the sensor, the surface photovoltage, δVₛ, may be determined from the measured signal, δVₘ, according to the relationships:
Re(δVₛ)=Re(δVₘ)−(1+C_{L}/Cₚ)+Im(δVₘ)·(ω·Cₚ·R_{L})⁻¹
Im(δVₛ)=Im(δVₘ)·(1+C_{L}/Cₚ)−Re(δVₘ)·(ω·Cₚ·R_{L})⁻¹
where Re(δVₛ) and Im(δVₛ) are the real and imaginary components of the voltage, ω is an angular frequency of light modulation, Cₚ is the capacitance between sensor and the wafer, and C_{L} and R_{L} are the input capacitance and resistance, respectively, of the electronic detection system.

From the sign of the imaginary component, the conductivity type may be determined. If the measurement is calibrated for a p-type material, then the sign of the imaginary component will change if the material is n-type.

Using above relationships, the depletion layer width, W_{d}, is given by equation:

$${W}_{d} = \frac{{ɛ}_{s}}{q} \frac{ω \vert Im ( δ {V}_{s} ) \vert}{ϕ ( 1 - R )} \cdot ( 1 + {[ \frac{Re ( δ {V}_{s} )}{Im ( δ {V}_{s} )} ]}^{2} )$$

where φ(1−R) is the intensity of light absorbed in the semiconductor, q is the elementary charge, and εₛ is the semiconductor permittivity.

In addition to the space-charge capacitance, C_{sc}, the measurement of the surface photovoltage can be used to determine the surface charge density, Qₛₛ, the doping concentration, N_{sc}, and the surface recombination lifetime, τ, using the following relationships. The space charge capacitance, C_{sc}, is proportional to the reciprocal of the semiconductor depletion layer width, W_{d}, according to the relationship:

$${C}_{sc} = \frac{{ɛ}_{s}}{{W}_{d}}$$

where εₛ is the semiconductor permittivity. The density of space charge, Q_{sc}, is in turn described by equation:
Q_{sc}=qN_{sc}W_{d}
where q is an elementary charge and the net doping concentration in the space-charge region, N_{sc}, is positive in an n-type material and negative in a p-type material. In addition, since the surface charge density, Q_{sc}, is given by the expression:
Q_{sc}=−Qₛₛ
the surface charge density is easily determined from the space charge density.

Further, if an inversion layer can be created at the wafer surface, the depletion layer width, W_{d}, under inversion conditions is related to the net doping concentration, N_{sc}, according to the relationship:

$${W}_{d} = \sqrt{\frac{4 {ɛ}_{s} kT ln ( \vert {N}_{sc} / {n}_{i} \vert )}{{q}^{2} \vert {N}_{sc} \vert}}$$

where kT is the thermal energy and nᵢ is the intrinsic concentration of free carriers in the semiconductor. Several methods of forming such an inversion layer at the semiconductor surface are disclosed below.

In addition, the surface recombination rate may also be determined from the SPV. The recombination lifetime of the minority carriers at the surface, τ, is given by the expression:

$$\frac{1}{ωτ} = \vert \frac{Re ( δ {V}_{s} )}{Im ( δ {V}_{s} )} \vert .$$

In general, the ac photovoltaic signal might be presented as

$${V}_{SPV} = \frac{{I}_{eh}}{G + jω C} ∝ \frac{{I}_{eh}}{{C}_{sc}} f ( {ωτ}_{s} ) .$$

Here Iₑₕ is an electron-hole generation rate, G and C are total conductance and capacitance of the system, ω is a light modulation frequency and τₛ is a carrier lifetime at the near surface region. The electron-hole generation rate is given by

$${I}_{eh} = q Φ ( 1 - R ) ( 1 - \frac{exp ( - α {W}_{d} )}{1 + α L} ) ,$$

where Φ is a photon flux, R and α are reflectivity and absorption coefficients, L is a carrier diffusion length and W_{d} is a depletion layer width. High defect density conditions αW_{d}<<1 and αL<<1 give us Iₑₕ∝qΦ(1−R)αL.

The diffusion length

$$L = \sqrt{( D τ )} ∝ 〈 τ 〉 \sqrt{\frac{kT}{m}} ∝ \frac{f ( E )}{{N}_{D}} \sqrt{\frac{kT}{m}} ,$$

where D is a diffusion coefficient, N_{D} is a number of defects/recombination centers, f(E) is a function of charge carrier energy, which depends on prevailing energy scattering mechanism, m is a charge carrier effective mass, k is a Boltzman constant.

Combining the last two expressions we get

$${I}_{eh} = \frac{q Φ ( 1 - R )}{{N}_{D}^{*}}$$

with

$${N}_{D}^{*} = {N}_{D} / α f ( E ) \sqrt{\frac{kT}{m}}$$

representing an effective defect density.

In one embodiment, the invention uses a fiber optic element with a conductive coating to measure wafer properties. The use of low amplitude modulation is suitable for an optical fiber based approach. The low amplitude modulation provides a linear signal response and a measurement of the surface depletion layer capacitance and conductance. The analysis of the fundamental components of the photosignal allows calculation of the critical material parameters, in crystalline silicon, in inversion conditions. The value of the depletion layer characteristics yields the semiconductor's doping concentration and recombination time. Another advantage of this linear response is that the illumination does not need to be uniform over the area in the linear response—a scaling property of conventional analysis, similar to the conventional capacitance/voltage analysis. In addition, the high frequency low level intensity illumination minimizes surface slow state charging.

Diagnostic areas on product wafers are typically 20 to 100 μm in dimension. The method described above can also be applied to take measurement on such small areas using the small spot size made possible using an optional fiber based probes. However, because the signal is proportional to the illuminated area, the detected signal is reduced by the square of the reduction in dimension. For example, for an average 60 μm spot, the SCP signals are approximately 1000 times weaker than the signals from a 2 mm spot of the wafer under measurement. SCP measurement is generated using low levels of short wavelength chopped light to modulate the semiconductor surface potential by a small fraction (0.001 to 0.01) of its static dark value, where the intensity of the light is much less than:

$$\frac{{W}_{d} N \sqrt{1 + {ω}^{2} {τ}^{2}}}{τ}$$

where W_{d} is the depletion layer width, N is the doping concentration, ω is the angular frequency of light modulation, and τ is the carrier lifetime at the near surface region. In order to improve the signal detection by approximately 1000 times to compensate for the reduction in area with the 60 μm illuminated spot, the parameters of the measurement have to be adjusted as follows, without exceeding the linear response and practicality of the measurement: 1) increasing light intensity by about 20 times; 2) increasing signal/noise detection by about 10 times; and 3) decreasing capacitance air gap by about 5 times. These adjustments result in a net gain of 1000 times, offsetting the signal loss due to area reduction.

The measurement method is compatible with patterned wafer processing where pre-measurement treatment on implanted patterned wafer may use low intensity UV exposure and thermal application so as to not impact the integrity of the masking pattern or underlying films. This is achieved by keeping the temperature range approximately less than 200 C. As outlined in U.S. Pat. No. 7,119,569, this UV exposure treatment stabilizes the silicon surface charge and accelerates the migration of interstitial silicon atoms from the bulk to the surface sink, stabilizing the bulk defect configuration at room temperature.

Alternatively, it is unnecessary to pre-treat the surface when using a high intensity light approach for micro-area analysis. In such an approach a high intensity pulse of light (possibly laser) flattens the surface barrier, which is recovered after the light is turned off. The surface charge in the test area and the recombination time can be extracted from analysis of amplitude and the recovery time of the photosignal response in the time domain.

One embodiment of the present invention focuses on a method and device to obtain a similar SCP measurement as described above and in U.S. Pat. No. 5,661,408, while targeting the a relatively small diagnostic area of product wafers so as to limit the use of monitor wafers.

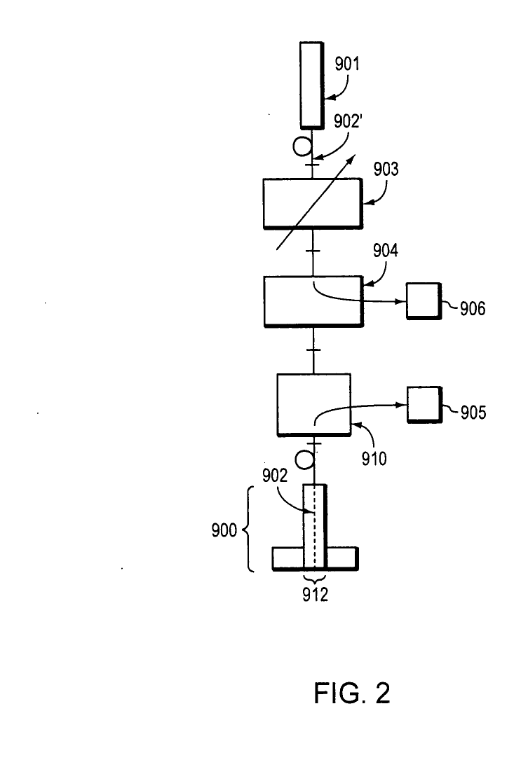

FIG. 2 illustrates a probe assembly 900 for taking measurements of a small area on the surface of a semiconductor wafer during manufacturing using induced surface photovoltage. As used herein, the probe assembly 900 can include various elements. However, in one general preferred embodiment, the probe assembly 900 includes an optical fiber 902 and an electrode 912 formed from a deposited conductive coating on a portion of the optical fiber 902. The probe assembly 900 may include other concentric layers such as a cladding or a ferrule. In one embodiment, as illustrated in FIG. 2, the optical fiber 902′ is in optical communication with laser 901. The fiber 902′ is doped so that when light from the laser 901 enters the fiber 902′, the fiber 902′ becomes a part of the laser 901, and together the laser 901 and fiber 902′ form the light source for the probe assembly 900. Alternatively, a 200 mW or variable red/blue multimode fiber laser with a 50 μm core can be used as the light source.

Still referring to FIG. 2, the fiber 902′ is connected to a variable power attenuator 903 by a ST connector. The variable power attenuator 903 adjusts the intensity of the transmitted light from the laser 901. A first splitter 904 splits the adjusted light and directs some of the light to a detector 906. The detector 906 measures the intensity and the uniformity of the light coming through. The rest of the light passes through a second splitter 910 and then through the probe assembly 900 onto a wafer being tested. Light reflected by the wafer surface travels back through the probe assembly 900 and is redirected by the second splitter 910 to a second detector 905 for measurement. The second splitter is unidirectional as it does not change the path of the light coming from the first splitter 904,

The probe assembly 900 illustrated in FIG. 2 offers two significant improvements over the regular probe assembly described previously in U.S. Pat. No. 5,661,408, when used for small area measurements. First, the probe assembly 900 performs the dual functions of applying light to the diagnostic site or open (unmasked) area on the patterned wafer and providing a non contact capacitively coupled electrode to sense the photovoltage induced with the applied light. Second, instead of applying low levels of AC modulated light at a fixed frequency, light with variable frequency and/or variable modulation (chopped) frequencies, between 1 kHz and 1 MHz, can be applied. A variable power light source may also be used but its intensity is kept low enough to maintain the desirable linearity of the SCP method.

Two preferred embodiments of the probe assembly 900 are discussed in detail below. The embodiments differ most substantially in how light is coupled from a variable power light source 901 to an electrode in the probe 900 and to the diagnostic areas being tested.

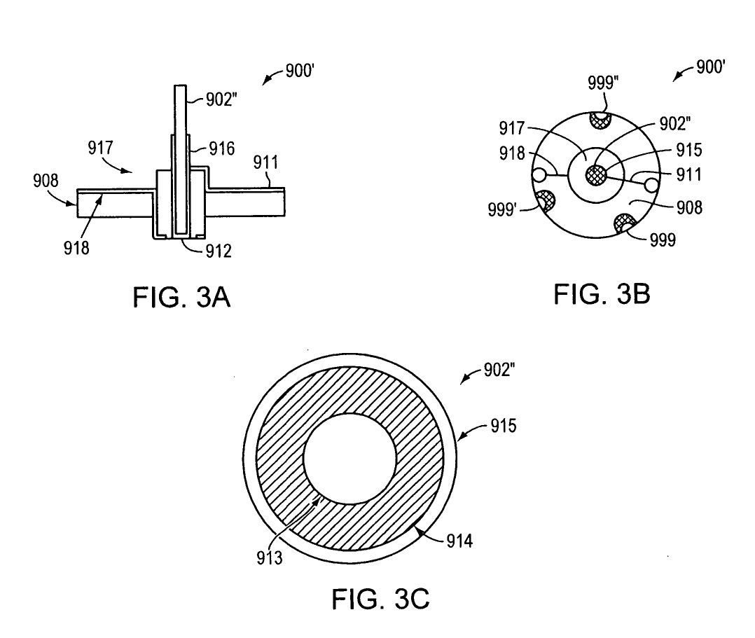

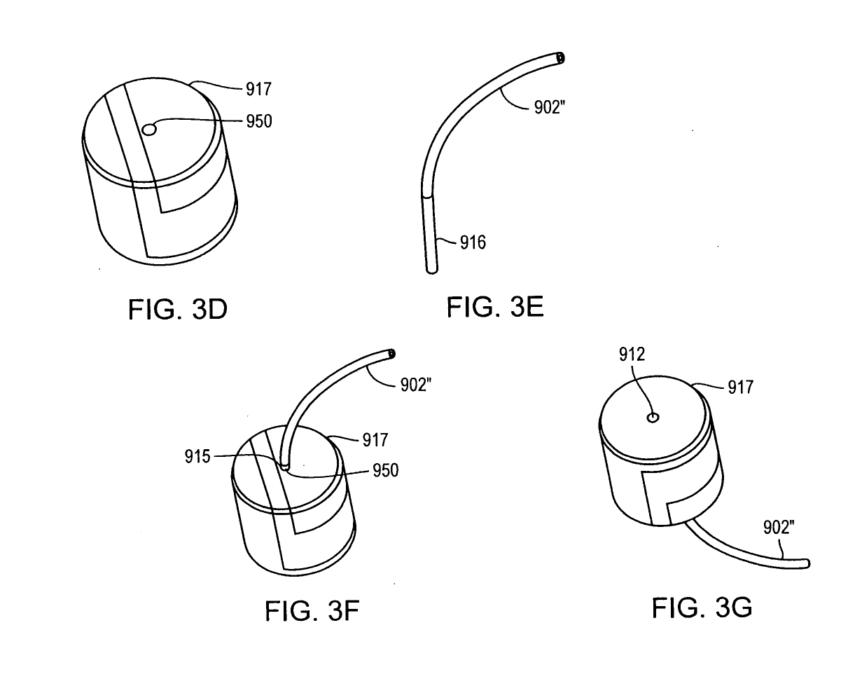

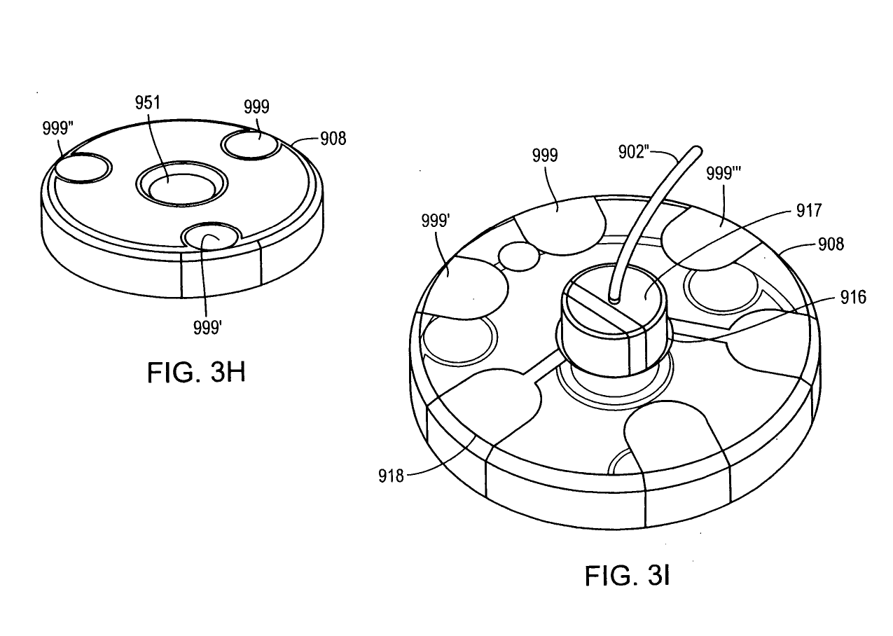

FIG. 3a provides a magnified view of a probe 900′. As illustrated, the probe 900′ includes one end of the optical fiber 902″ originated from the light source (as shown in FIG. 2), a ferrule 917 holding the optical fiber 902″ and a guard ring 908 supporting the ferrule 917. The optical fiber 902″ is coated with an electrically conductive layer 916, which covers the side of the fiber 902″ and across the endface 912 of the fiber 902″. In one embodiment, this layer is like a sleeve that partially covers the length and the end face 912 of the fiber 902″. The conductive layer 916 is optically transparent and thus allows light to pass through without changing the light's direction and intensity. In one embodiment, the transparent conductive coating 916 is a layer of indium tin oxide (“ITO”).

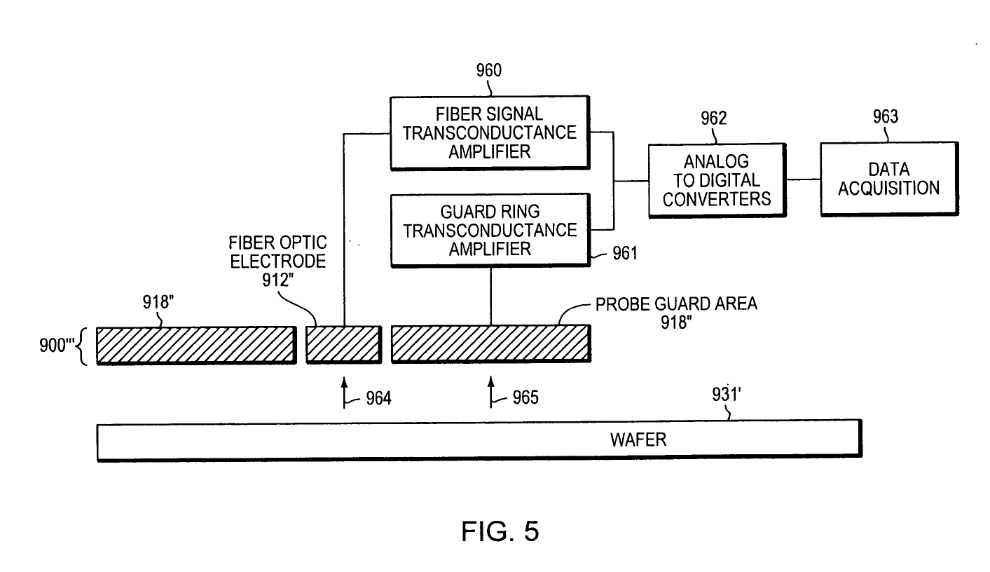

When the probe 900 is positioned over a wafer, light from the optical fiber 902″ strikes the wafer surface and causes photo disassociation of the electrons on the surface of the wafer. As a result, the separation of the electrons and holes generates an electrical field, which is detected by the conductive coating on the endface 912 of the fiber 902″, functioning as an electrode. The signals from the electrical field then travel through the coating on the side of the fiber to an electronic connector 911 extending across the top surface of the guard ring 908. The electronic connector 911 is connected to support electronics that further processes the signals generated in response to the electrical field. More details of the support electronics are provided below with reference to FIG. 5. In addition, the guard ring 908 also includes a grounding electrode 918 extending from its surface down the side and the bottom of the ferrule as an electrical guard plane to shield the conductive coating on the endface 912 and along the side of the fiber 902″ from extraneous signals from the wafer surface. The grounding electrode 918 is isolated from the conductive coating of the fiber 902″

FIG. 3b is a top cross-section view of the probe 900′ of FIG. 3a. As illustrated, the center shaded circle represents the cross-section of the optical fiber 902″ having an conductive coating (not shown). The optical fiber 902″ is held by a ferrule 917. In one embodiment, between the optical fiber 902″ and the ferrule is an isolation layer 915 (dotted circle), isolating the conductive coating of the fiber 902″ from the ferrule 917. The ferrule 917, in turn, is positioned in an annular guard ring 908. As in FIG. 3a, positioned on the top surface of the guard ring 908, an electronic connector 911 connects the conductive coating of the optical fiber 902″ to supporting electronics (not shown) so that signals can be transmitted to the supporting electronics for processing. Also shown is a grounding electrode 918 extending from the edge of the guard ring 908 to the side of the ferrule 917. The grounding electrode shields the conductive coating of the fiber 902″ from extraneous signals from the wafer surface. In addition, three leveling electrodes 999, 999′, 999″ are positioned around the edges of the guard ring 908 for measuring the electrical field between the guard ring 908 and the wafer. The measurements from the leveling electrodes 999, 999′, 999″ keep the guard ring 908 at a level position with respect to the wafer surface so that the endface of the fiber 902″ can also be level to the wafer surface.

The composition of the optical fiber 902″ of FIG. 3b is illustrated in more detail in FIG. 3c. The three layers from the center out are respectively: the fiber core 913, the cladding 914 and the isolation layer 915 which isolates the conductive coating (not shown) of the fiber 902″ from the ferrule (not shown). Because the fiber core 913 has a relatively small dimension (about 60 μm), similar to the small spot subject to test on the wafer, this embodiment of the probe using optical fiber as a light path is ideal for small spot measurements. In some embodiments, the fiber core is multimode or single mode.

FIG. 3d is a perspective view of the ferrule 917 having a central axial bore 950 where an optical fiber can be inserted and secured. FIG. 3e is a perspective view of an optical fiber 902″ that is the center piece of the probe of FIG. 3a. An electrically conductive layer 916 is shown coating the end of the optical fiber 902″ facing the wafer surface. FIGS. 3f and 3g are, respectively, top and bottom perspective views of the optical fiber 902″ of FIG. 3e inserted in the ferrule 917 of FIG. 3d. In one embodiment, as illustrated in FIG. 3g, the end face 912 of the optical fiber 902″ is coplanar with the bottom of the ferrule 917.

FIG. 3h provides a perspective view of the guard ring 908 used to support the ferrule (not shown), the guard ring 908 having three leveling electrodes 999, 999′, 999″ around its edge for keeping the guard ring 908 in a level position with respect to the wafer surface. FIG. 3i offers a top perspective view of the entire probe assembly wherein the optic fiber 902″ is secured by the ferrule 917 and the ferrule 917 is supported by the guard ring 908. A grounding electrode 918 extends from the edge of the guard ring 908 to the side of the ferrule 917. The grounding electrode shields the conductive coating of the fiber 902″ from extraneous signals from the wafer surface. As in FIG. 3h, leveling electrodes 999, 999′, 999″ are attached to the guard ring 908 to keep it level.

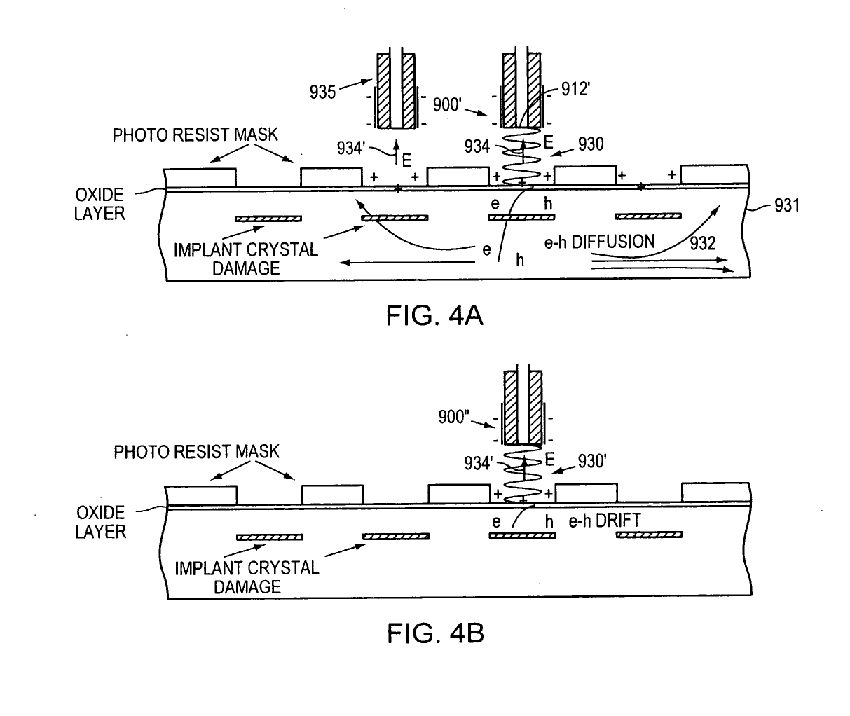

FIGS. 4a and 4b are block diagrams illustrating the probe assembly of FIG. 3a in operation and the effect of the wavelength of the illuminating light on the measurement taken. In general, light having a long wavelength, such as visible IR light 930 shown in FIG. 4a, is able to penetrate deeper into the semiconductor 931 than light with shorter wavelength such as the UV light 930′ in FIG. 4b.

Referring to FIG. 4a, light 930 from the fiber of the probe assembly 900′ strikes the wafer surface and causes photo disassociation of the electrons on the surface of the wafer. As a result, the separation of the electrons and holes generates an electrical field 934, which is detected by the conductive coating on the endface 912′ of fiber of the probe 900′, functioning as an electrode. However, the deep penetration of near IR light 930 also causes diffusion of electrons and holes in the semiconductor 931 and thus provides information on the lateral and bulk motion of photocarriers 932. Because the probe 900, as describe above, only has a small surface region 912′ of conductive coating at it bottom to detect the field 934 directly beneath it, the probe 900′ is not likely able to pick up electrical field 934′ caused by from diffusion of the electrons and holes at adjacent spots above the wafer surface. As a result, a second photodetector 935 is positioned above an adjacent spot of the semiconductor surface to detect the diffused charges. In one embodiment, the distance between the probe 900′ and the photodetector 935 is the same as the distance between the testing spot underneath the probe and the adjacent spot. In addition, the probe 900′ and the photodetector 935 have to be positioned over clean untreated spot on the semiconductor surface to make measurements.

Referring to FIG. 4b, in contrast, short wavelength visible ultraviolet (“UV”) light 930′ only provides measurement specific to the diagnostic spot because the UV light does not penetrate deep below the semiconductor surface to cause any diffusion. A single probe 900″ is adequate to detect the electrical field 934′ generated from the drift of the electrons and holes in the semiconductor caused by the UV light.

FIG. 5 illustrates how the probe 900′″ is electronically attached to the supporting electronics. More specifically, FIG. 5 shows the process of converting signals received from the wafer surface into a digital data format that can be stored and processed by computer. In this embodiment, the signals 964 captured by the coated endface of the optical fiber 912″ are transmitted to a fiber signal transconductance amplifier 960. Similarly, signals 965 detected by the grounding electrode 918″ on the guard ring are transmitted to a guard ring transconductance amplifier 961. Because the signals 964, 965 received are weaker due to the small area of the semiconductor being measured, the amplifiers 960, 961 slightly amplifies the respective signals so that they can be converted from analog format to digital format by an analog-to-digital converter 962. The digital data is then acquired by a data acquisition 963.

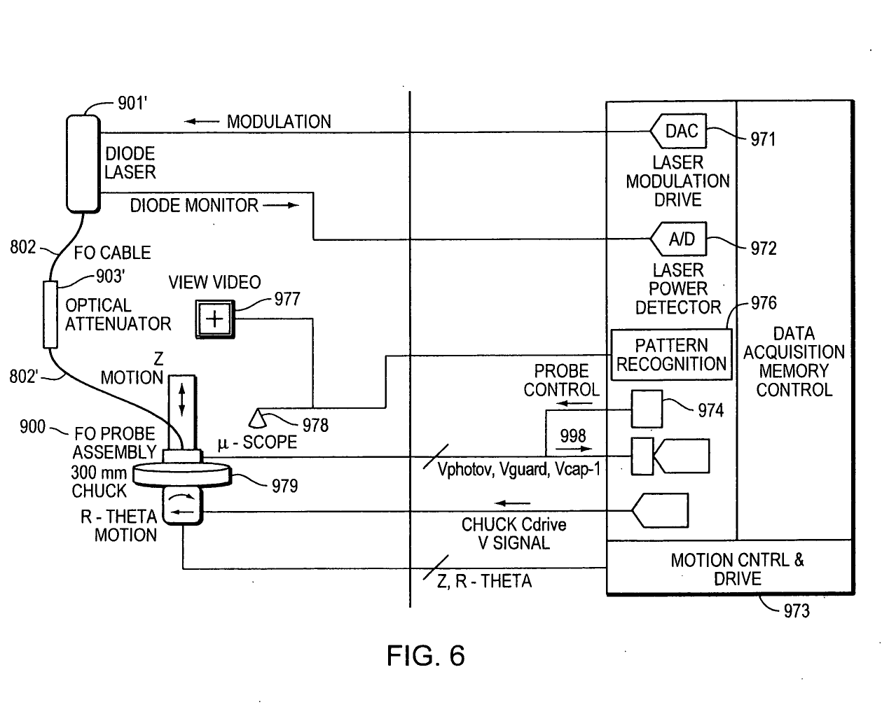

FIG. 6 is a detailed diagram illustrating an embodiment of the probe assembly 900 and the supporting electronics 970 for controlling the probe assembly 900. A diode laser 901, an optical attenuator 903′ and the probe assembly 900 are connected by optical cables 802, 802′. A digital-to-analog converter 971 modulates the light of the diode laser 901′ and a laser power detector 972 detects the intensity of the laser light. In one embodiment, the laser power detector is connected to the optical attenuator 903′ and detects the intensity of the adjusted light coming out of the attenuator 903′ instead of the laser.

As illustrated, the probe assembly 900 stands on a chuck 979. The chuck 979 is movable vertically in the Z direction and also in the R-Theta coordinates so that the probe can be moved with the chuck to any position above the wafer to measure any clean untreated spot on the wafer. A probe control module 974 and a chuck motion control module 973 controls the movement of the probe and the movement of the chuck 906, respectively. A microscope 978 is positioned above to the wafer to locate any untreated spot to be measured. The images from the microscope 978 are sent to a monitor 977 for viewing. In one embodiment, the images can also be input to a pattern recognition module 976 so that untreated spots can be recognized automatically by the software of the pattern recognition module 976, without being displayed.

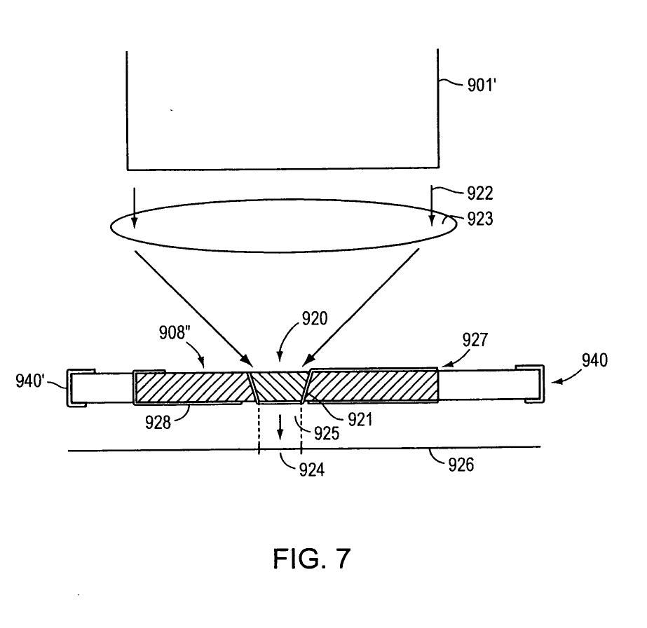

An alternative embodiment of the probe assembly uses a probe cone extension on a lens assembly instead of fiber optics. Referring to FIG. 7, the cone 920 made of approximately 60 um width of transparent material, e.g. quartz, truncated and polished flat at its small and large ends. The cone 920 is fitted in a central conical depression 921 in an opaque sensor disk 908″ with a size of approximately 2×2 mm. The source of modulated light 901′, a laser in one embodiment, directs a collimated beam 922 to a lens assembly 923 which focuses the light down to diagnostic area 924 dimensions through the probe cone extension 920 to its small end 925, the dimension of which coincides with the dimension of the diagnostic area 924. This small end is coated with a transparent conductive layer, as are the conical sides. The conductive layer serves as the pick-up electrode for receiving and conveying signal up and away from the wafer surface 926 to an electronic connector 927 on the top of the surrounding guard ring 908″. The signal is then detected by a photo detector (not shown) and subjected to measurements. A guard ring 908″ similar to the one discussed in previous embodiment is also used here to support the cone 920. The bottom side of the guard ring 908″ is also coated with a conductive film 928 which serves as an electrical guard plane to shield the central cone conductor 921 from extraneous photo signals. Multiple leveling electrodes 940, 940″ are coupled to the guard ring 908″ to keep the guard ring 908″ and the embedded probe cone extension 920 in a position parallel to the surface of the semiconductor 926.

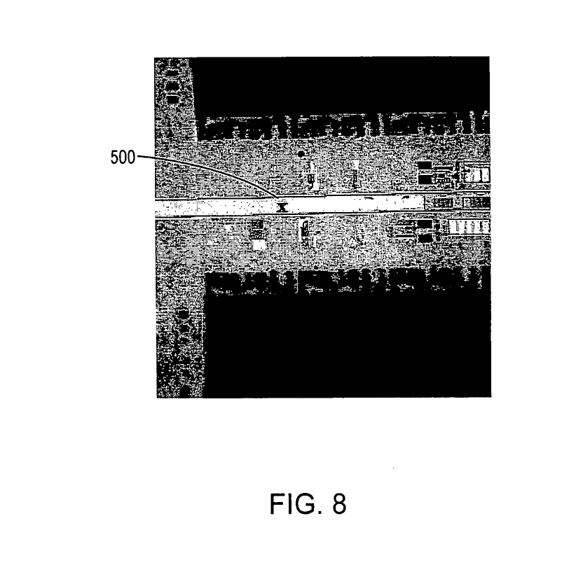

FIG. 8 illustrates illumination of a typical diagnostic area in a partially processed, patterned wafer. “X” 500 marks the spot under measurement. The images illustrate the fact that, depending on the specific wafer pattern, the probing light may or may not be confined to the test area, which makes use of the electrically guarded probe a necessity.

Although the embodiments disclosed above are discussed in the scope of providing solutions in response to a request for a medical service, one of ordinary skill in the art can easily adopt the same methods and systems for the providing of other type of services. Variations, modifications, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

What is claimed is:

1. A probe adapted for characterization of a semiconductor material having a surface, the probe comprising:
a source of electromagnetic radiation;
an optical fiber portion having a transmission endface, the optical fiber portion in communication with the source of electromagnetic radiation; and
a transparent probe section having a substantially planar conductive endface, the transparent probe section positioned relative to the transmission endface such that electrical changes induced in the semiconductor material in response to the electromagnetic radiation are received by the conductive endface.

2. The probe of claim 1 wherein the conductive endface senses photovoltage induced on a surface of the semiconductor material by electromagnetic radiation I from the source.

3. The probe of claim 2 wherein the semiconductor material is a semiconductor wafer.

4. The probe of claim 1 wherein the source is light emitting diode.

5. The probe of claim 4 wherein the conductive endface is a cap with a substantially planar surface.

6. The probe of claim 5 wherein the conductive endface comprises ITO.

7. The probe of claim 1 further comprising a digital signal processor adapted to process electrical signals induced in the conductive endface.

8. The probe of claim 1 wherein the probe section comprises a conductive coating that encircles a length of the fiber portion and is in electrical communication with the conductive endface.

9. The probe of claim 1 wherein the electromagnetic radiation generates a spot on a surface of the semiconductor material below the transmission endface, the spot associated with at least one wavelength.

10. The probe of claim 9 wherein the at least one wavelength is selected from the group consisting of visible light, infrared light; near infrared light, long visible, short visible, and ultraviolet.

11. The probe of claim 10 further comprising a photodetector in optical communication with the fiber portion to provide feedback regarding probe operational parameters.

12. A probe for adapted for characterization of a semiconductor wafer having a surface, the probe comprising:
a source of modulated light adapted to generate light of varying wavelengths;
an optical fiber in optical communication with the source of modulated light, the optical fiber having an endface and comprising:
a fiber core; and
a transparent conductive layer coating the face of the optical fiber,
wherein light from the source of modulated light is directed along the fiber core of the optical fiber through the face of the optical fiber to the surface of the semiconductor wafer, and
wherein charges from the surface of the semiconductor wafer are detected by the transparent conductive layer.

13. The probe of claim 12 wherein the transparent conductive layer extends along a fiber cladding.

14. The probe of claim 12 further comprising a photo detector connected to the transparent conductive layer.

15. The probe of claim 12 wherein there is space between the face of the optical fiber and the surface of the semiconductor.

16. The probe of claim 12 further comprising a ferrule, wherein the ferrule holds the optical fiber at a fixed distance from the surface of the semiconductor and parallel to the surface of the semiconductor.

17. The probe of claim 16 wherein the ferrule is non-conductive.

18. The probe of claim 12 further comprising an opaque sensor disk having a bottom side,
wherein the bottom side of the opaque sensor disk is coated with a conductive film which shields the transparent conductive layer from extraneous photo signals.

19. A method of characterizing a portion of a semiconductor material, the method comprising the steps of
transmitting electromagnetic radiation using an optical fiber such that the electromagnetic radiation a) propagates through a substantially planar conductive probe endface in communication with the optical fiber and b) impinges on a surface of the semiconductor material; and
detecting an electrical signal associated with an electrical change induced in the portion of the semiconductor material in response to the electromagnetic radiation, wherein the electrical signal is detected using the conductive probe endface.
